(19) United States
(12) Patent Application Publication
(10) Pub. No.: US 2002/0105665 A1
(43) Pub. Date: Aug. 8, 2002

(54) Method of interating imaging products/services with non-imaging products/services in a single kiosk

(75) Inventors: Jerome J. Wasilewski, Rochester, NY (US); Daniel J. Abens, Webster, NY (US)

Correspondence Address: Patent Legal Staff, Eastman Kodak Company, 343 State Street, Rochester, NY, 14650-2201, US

(73) Assignee: Eastman Kodak Company

(21) Appl. No.: 09/779,335

(22) Filed: Feb. 8, 2001

(51) Int. Cl. G06K 15/02; G06K 9/00; G06K 9/20; G06F 13/00; G06F 15/00; G06F 3/12; G06K 9/36; G06T 5/00

(52) U.S. Cl. 358/1.13; 358/3.28; 382/115; 358/1.18; 382/118; 382/119; 358/1.15

(57) ABSTRACT

A method of integrating photographic imaging products and services functionality with non-imaging functionality using the automatic teller machine (ATM) functions for providing financial transactions as the preferred embodiment wherein a single kiosk is disclosed. This invention provides the consumer with the flexibility to generate imaging products and conduct imaging services or perform ATM-related transactions independent of one another; to incorporate images into producing customized financial instruments at the kiosk; to access financial institution services to store or retrieve images as part of providing either imaging products/services or ATM financial instruments; and to utilize the customer's financial accounts and/or financial instruments as a means for payment of imaging products/services rendered at the kiosk. The present invention leverages the infrastructure, equipment and networking capabilities of both sets of functionality to provide an economy of scale and an increased value of differentiation not currently available.

### FIELD OF THE INVENTION

The invention relates to the field of kiosks, and more particularly, to a combined kiosk for photographic image producing image goods and/or service kiosks and non-imaging products and/or services such as an Automatic Teller Machine (ATM) kiosk.

### BACKGROUND OF THE INVENTION

Image-producing kiosks are well known. An example is the Kodak Picture Maker™. This kiosk is capable of scanning prints to create a digital image file, importing digital image files from various media or from remote storage via a network connection, and creating reprints and enlargements from the scan or digital image file. The kiosk can also add borders and do other manipulations to the image to increase its value. It is known to network image-producing kiosks, capable of sending to and receiving files from a remote location, as well as providing credit card transaction processing.

U.S. Pat. No. 5,459,819 is directed to a kiosk focused on the flexibility of generating a combined, composite image from a variety of source images and is limited to image generation; which, in part, provides the input for the image producing products/services functionality of the integrated kiosk.

U.S. Pat. Nos. 5,623,581; 5,913,019 are both limited to capturing an image, superimposing it on a selected background and having the composite image printed as a set of stickers; it does not address the flexibility of creating an image from a single or multiple set of image captures and performing edits and enhancements to produce a multiplicity of image products and services.

Automatic Teller Machine (ATM) kiosks are also well known. This kiosk is capable of accessing a customer financial banking account for status, as well as to credit, debit and transfer monetary funds. It is also capable to accept a physical monetary deposit and/or withdrawal, along with disbursement of funds. They are typically networked through the financial institution infrastructure. They may also have a security monitoring camera device. ATMs today are limited to disbursement of bank notes/cash or goods, as from a vending machine. They do not address the generation of personal bank products using imaging (either in the process or integral to the bank product), nor does it address the creation of imaging goods and providing of imaging services as part of its disbursement process.

U.S. Pat. No. 5,764,789 discloses the use of biometrics as part of the personal authentication process for customers to access their financial account. It does not address its use as a digital watermark to secure a transaction nor its incorporation into a kiosk product.

U.S. Pat. Nos. 5,859,920; 5,905,819; 6,044,182; 6,136,752 disclose the method of embedding digital information in an image and of providing image authentication; it does not address the flexibility and enhancement in the use of watermarked images into non-imaging applications or its incorporation into a kiosk product/service.

U.S. Pat. No. 5,774,663 discloses the communications between a customer and a specific financial institution. This patent does not address employing a third party in the financial transaction process.

Internet kiosks are also known. Through browser technology and Internet access, one can search the World Wide Web (WWW) to gain access to a number of web sites. U.S. Pat. No. 5,761,071 discloses the use of browser technology as the kiosk graphical user interface interaction with the user for a standalone, Internet-accessible kiosk; however, it does not address the image and non-imaging functionality within the integrated kiosk for providing products and services associated with that functionality. These web sites can only offer a wide variety of imaging and non-imaging (such as banking) products/services that can be fulfilled within their supporting infrastructure and then distributed to the customer either via the Internet or physically shipped.

However, the prior art fails to teach or suggest a method by which the functionality of an imaging producing kiosk is integrated with the functionality of a non-imaging producing kiosk, such as an ATM kiosk, into a single kiosk, that dispenses products and services associated with both types of functionality at the kiosk.

There is a need to provide a kiosk with the ability to import photographic images (i.e.; scanned from film; transferred digitally from a digital still camera, hand-held device or memory device; or downloaded from an Internet-enabled storage location); process digital photographic images (i.e.; remove ‘red eye’, zoom and crop, add borders and text, etc.); provide print fulfillment services (i.e.; outputting hardcopy print product or digital file at the kiosk, sending e-mail product services, uploading & downloading the digital file to/from an Internet-enabled remote storage location or to remotely print and distribute images); and the ability to conduct a plurality of financial transactions that use imaging as part of its product/service.

A kiosk made in accordance with the present invention leverages the usage of the existing infrastructure, as well as equipment and networking capabilities across functionality types (that is, imaging and non-imaging) verses the placement of two separate, individual kiosks. Cost reduction, through elimination of redundant equipment and more use efficiency of the kiosk is achieved.

The present invention also provides the ability to generate custom financial instruments (e.g.; debit card, credit card, traveler checks) with a specific selected image, for example an image of the recipient, to provide added security against fraudulent transactions. Through image processing techniques, the subject is isolated from the background to provide a distinct image for these financial instruments, as well as for image products. Enhanced security and authorization is also achieved by applying the image captured with a personal identifier scanning device for comparison to a remote database via the communication network. Also, utilizing the network, remote financial transactions using personal identification information can be rendered locally at the integrated kiosk.

Recognizing that both secure and non-secure access is required to maintain the integrated kiosk, it is envisioned that a kiosk made in accordance with the present invention will have separate access means to handle each need (e.g.; routine consumer replenishment, printer servicing, cash deposit removal, etc.).

### SUMMARY OF THE INVENTION

This invention describes the methods for using an individually integrated kiosk that combines the photographic imaging products/services functionality of an imaging kiosk, with the non-imaging products/services functionality of a non-imaging type kiosk, using Automatic Teller Machine (ATM) functionality as the preferred embodiment.

According to one aspect of the present invention, there is provided a consumer kiosk for providing at least one imaging service and at least one non-imaging service, the kiosk comprising:

a customer input device;

a computer device;

a display device; and

an image capture device for capturing an image at the kiosk which is to be utilized by each of the at least two different services.

In accordance with another aspect of the present invention there is provided a customer kiosk for providing financial and imaging goods and/or services, comprising:

a customer input device;

a display device;

a mechanism for receiving and/or providing monetary transfer by the customer; and

a scanning device for scanning of documents provided to the kiosk.

In yet another aspect of the present invention there is provided a system for providing remote financial transactions, comprising:

a customer kiosk for providing financial and imaging goods and/or services, the kiosk having a customer input device; a display device; a mechanism for receiving and/or providing monetary transfer by the customer; and a scanning device for scanning of documents provided to the kiosk; and a communication mechanism for communicating with a computer system at a remote location and providing information to the computer system obtained by the scanning mechanism;

the computer system having a display device for viewing of information provide by the kiosk, a software program for analyzing the information for confirming the information is authentic and authorizing a financial transaction based on the analyzing of the information.

In still another aspect of the present invention there is provided a method for providing financial and imaging goods and/or services from a kiosk having a customer input scanning device and a display device, the method comprising:

providing a financial document to the input scanning device, the financial document being issued to the user and having user identification;

scanning the financial document provided to the kiosk and obtaining the user identification; and

providing confirmation data to the kiosk for verification of the user identification.

In yet another aspect of the present invention there is provided method for conducting a financial transaction by a customer at a remote kiosk, comprising the steps of:

a. obtaining initial information about the customer at the kiosk;

b. obtaining corresponding information about the customer from a remote location;

c. comparing the initial information with the corresponding information for confirming the authenticity of the initial information; and

d. conducting a financial transaction based on the confirmation of the authenticity of the initial information.

In another aspect of the present invention there is provided a computer software product comprising a computer readable storage medium having a computer program which when loaded into a computer in a kiosk having a customer input scanning device and a display device causes the computer to perform the following steps:

a. scanning the financial document provided to the kiosk and obtaining the user identification; and

b. providing confirmation data to the kiosk for verification of the user identification.

In yet another aspect of the present invention there is provided a computer software product comprising a computer readable storage medium having a computer program which when loaded into a computer in a kiosk causes the computer to perform the following steps:

a. obtaining initial information about the customer at the kiosk;

b. obtaining corresponding information about the customer from a remote location;

c. comparing the initial information with the corresponding information for confirming the authenticity of the initial information; and

d. conducting a financial transaction based on the confirmation of the authenticity of the initial information.

These and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

In the detailed description of the preferred embodiments of the invention presented below, reference is made to the accompanying drawings in which:

FIG. 1 illustrates a prior art image-producing kiosk;

FIG. 2 illustrates a prior art ATM kiosk, as a non-imaging producing kiosk;

FIG. 3 illustrates an integrated kiosk made in accordance with the present invention having the capability to provide both imaging and non-imaging products/services;

FIG. 4 set forth a list of common architecture elements of a prior art kiosk of FIG. 1 and prior art kiosk of FIG. 2;

FIG. 5 illustrates a flow chart of method for dispensing imaging products and/or services from an integrated kiosk made in accordance with the present invention;

FIG. 6 illustrates a flow chart of methods for dispensing ATM products/services from an integrated kiosk made in accordance with present invention;

FIG. 7 illustrated a custom product produced from a kiosk made in accordance with the present invention; and

FIG. 8 illustrated a system for utilizing remote services and applications of an integrated kiosk made in accordance with the present invention.

### DETAILED DESCRIPTION OF THE INVENTION

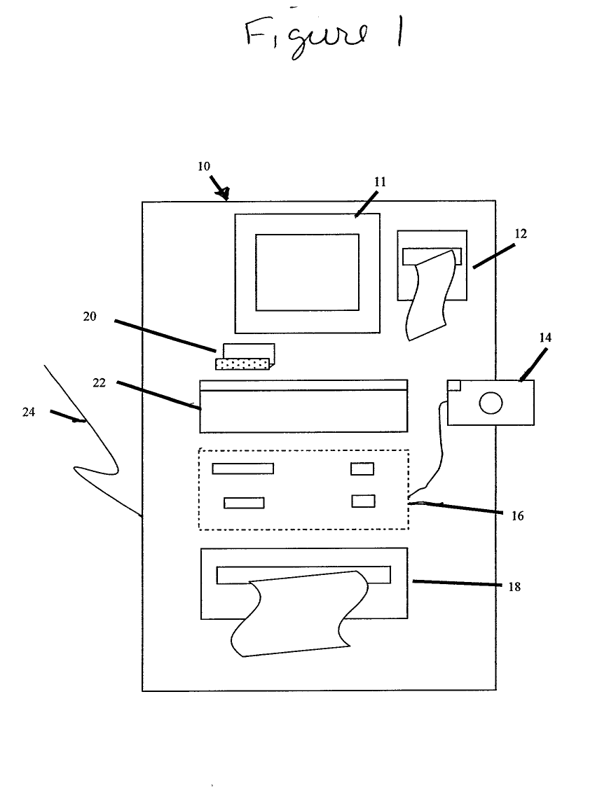

Referring to FIG. 1, there is illustrated a prior art kiosk 10 which provides imaging products and services. Kiosk 10 represents a composite of key components for producing imaging products and providing imaging services. The kiosk 10 includes a touch screen user interface 11 which provides user instructions and/or prompts and allows data entry by the user to kiosk 10. In the embodiment illustrated the screen user interface 11 comprises a touch screen as is well known in the art. The user can scan a photo or other document using the image scanner 22 or, if available, use an attached digital image camera 14 to capture a digital image. A computer 16 is provided in kiosk 10 for controlling operation of the kiosk 10. The kiosk 10 may also be equipped with peripherals to read digital image files from various sources such memory cards and portable storage devices like CDs, memory sticks, camera memory cards and floppy/zip disks. Through the user interface 11 and application software that resides in the computer 16, the consumer/customer selects an imaging product or service, and is then instructed to perform the appropriate set of operations. This may include financial transaction payment of the imaging product/service using a multi-card reader 20 for credit card, debit card or smart card processing. A network connection 24 is provided in kiosk 10 that is used to support the transaction processing, as well as provide other appropriate network services and support. Upon approval of payment, image product is generated. For example a small size image printer 12 is provided in kiosk 10 for use in generating photo ID or small sticker sheet output. In addition a larger size image printer 18 may be provided for generating larger image reproduction or large sticker sheet output. Other image product outputs are provided over-the-counter or sent to the consumer.

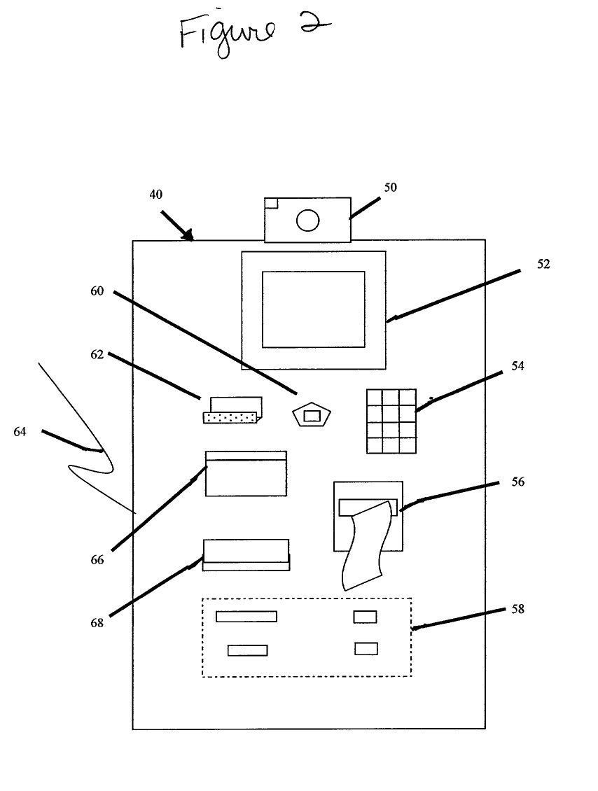

Referring to FIG. 2, there is illustrated a typical prior art ATM kiosk 40 used for financial transactions provided by a financial institution. A security camera 50 typically monitors the consumer at the kiosk 40. Through a user display device 52 provided on kiosk 40, the consumer is instructed to select the desired transaction and use data entry device 54 for selections and data entry. In the embodiment illustrated display device 52 comprises a CRT and data entry device 54 comprises a key pad. It is to be understood that display device 52 and data entry device 54 may be any well known substitute. Kiosk 40 includes control and application software that resides on an associated computer 58 also provided in kiosk 40. A network connection 64 is provided in kiosk 40 to support the transaction processing. For any deposits, the consumer uses an envelope deposit slot 66 provided on kiosk 40. For transactions requiring a credit card, debit card or smart card, the consumer swipes it through the multi-card reader 62 provided on kiosk 40. When a transaction requires the consumer to provide a written signature or a biometric fingerprint, the writing pad/sensor plate 60 provided on kiosk 40 is used. Any disbursement transaction would be made to the consumer via the financial instrument dispenser 68. The receipt printer 56 provided on kiosk 40 generates a printout confirmation of the processed transaction.

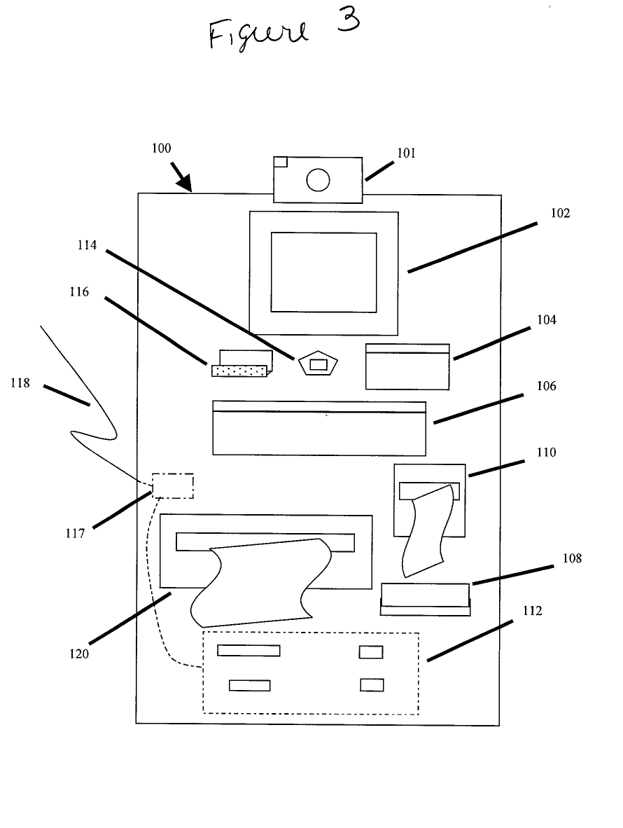

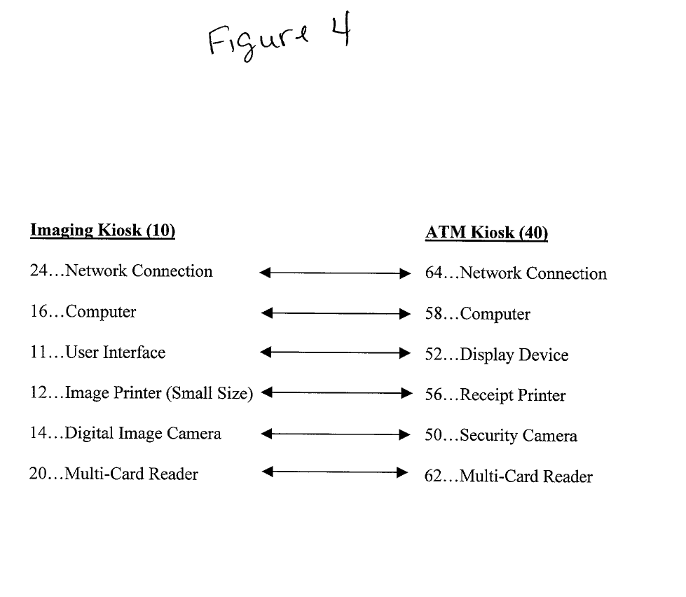

Referring to FIG. 3, there is illustrated a kiosk 100 made in accordance with the present invention. The kiosk 100 incorporates the functionality of both an imaging kiosk and an ATM kiosk into a single kiosk unit. FIG. 4 set forth a list of common architecture elements of a prior art kiosk of FIG. 1 and prior art kiosk of FIG. 2. The kiosk 100 includes a customer input device and display device. In the embodiment illustrated, the kiosk 100 uses a touch display screen user interface 102 as a display device to display instructions and prompts, and as an input device to for allowing a customer to enter data for conducting its business. It is of course understood that any appropriate display device and/or data entry device may be employed to support the functions of the kiosk 100. The kiosk 100 includes an imaging camera 101 provides both security monitoring, personal identification and a means for capturing an image for image-based products. Alternately, the customer can capture a digital image from a photograph using the image scanner 106 provided on kiosk 100 or import a digital image file stored on various media (e.g., CD, memory card/stick or disk) using the various input devices not shown, but provided, on kiosk 100. These devices are appropriately connected to a computer 112 provided in kiosk 100. The computer 112 also controls kiosk 100 and uses the appropriate software applications for supporting operations at kiosk 100. The kiosk 100 also includes a communication device 117 for providing communication over a network connection 118 that supports the transaction processing and other application communication network services and support, such as “back lab processing” for high volume image printing. The network connection 118 may be of a broad bandwidth type or of a low bandwidth type, the broad bandwidth being used for large files, such as image files, and the low bandwidth type being used for transmission of small data files. For example, a phone line may be used for the small data files and a cable type connection could be used for large image type files. Preferably, the kiosk 100 would have both types of connections. In addition the kiosk 100 may employ data compression algorithms to support transmission of data.

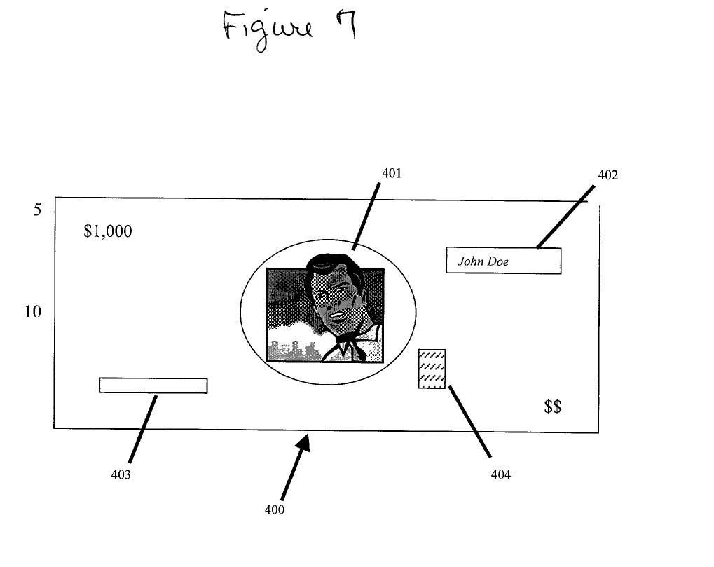

For a financial transaction requiring a monetary deposit, the consumer uses the envelope deposit slot 104. For imaging or ATM transactions requiring a credit card, debit card or smart card, the consumer swipes it through the multi-card reader 116. Where a product or service requires the consumer to provide personal identification through a written signature or a biometric fingerprint, a writing pad/sensor plate 114 provided on kiosk 100 is used. The imaging camera 101 would be used for personal identification, providing visualization verification of the customer or other individual at kiosk 100 as well as being the capture device for biometric iris scanning. Upon payment approval, imaging and financial products are generated by kiosk 100. A small size image printer 110 provided on kiosk 100 is used for small-sized various imaging products. In the embodiment illustrated, printer 110 can be used to produce personalized financial instruments such as traveler checks as illustrated in FIG. 7. Kiosk 100 in the preferred embodiment also included a large size image printer 120 for larger-sized imaging products. Financial instrument disbursements, as part of a financial transaction, are made to the consumer using the financial instrument dispenser 108. A receipt printout, confirming the processed transaction, is generated by smaller size printer 110

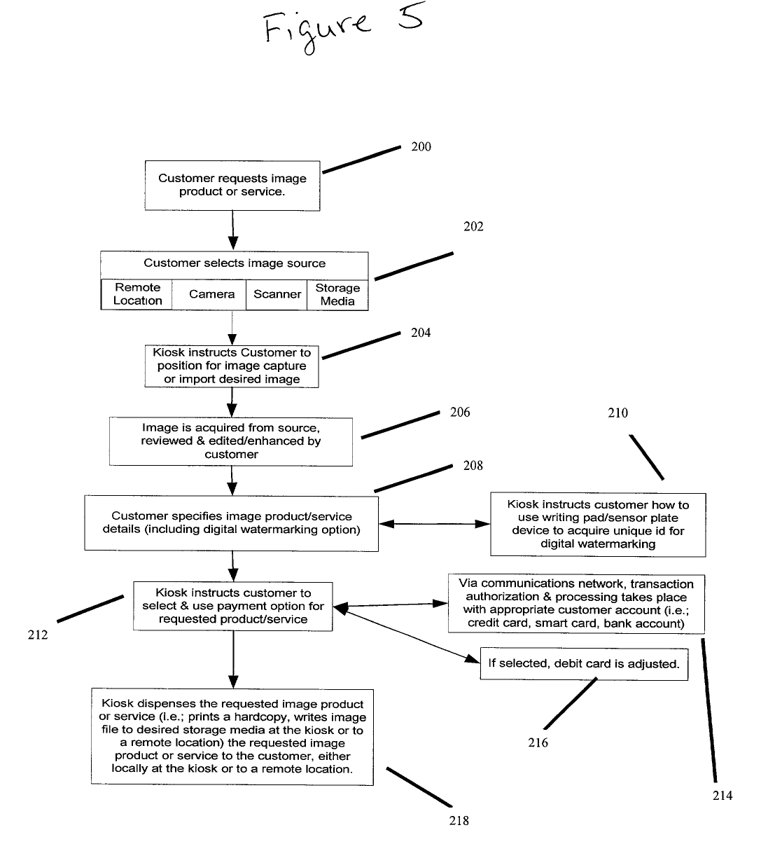

The kiosk 100 may be used for ordering of image products and/or services or as an ATM. Referring to FIG. 5 there is shown a flow diagram of one type of operation of the kiosk 100. When a customer, desires to request an image product and/or service 200, the customer initiates a request on kiosk 100 and follows the prompts on the touch screen user interface 102. The customer selects the image source 202 of an image. For example obtain an image from a remote location via the network connection 118, imaging camera 101, image scanner 106, or from a file stored on media such as a CD, memory card/stick, disk using the peripheral options available on the computer 112, so as to begin the image acquisition process 204. Once the image is acquired, the customer can perform any image edits or enhancements allowed by kiosk 100 to get the desired image 206 for the image product/service. The customer is also prompted to select the particular image product/service 208. Prior to rendering the image product/service, the customer is prompted to select desired payment method, for example debit card, credit card, smart card, payment via ATM functionality using uses either the multi-card reader 116 or ATM process 214; 216, via communication device 117 over the network connection 118. The multi-card reader 116 has magnetic, optical and computer chip reading capability to perform the transaction for the image product/service. Upon payment approval, the kiosk dispenses the requested image product or service 218. If selected, digital prints are generated at the large size image printer 120. Photo ID or Photo Sticker selections are produced at the small size image printer 110. Other outputs at the kiosk include CD, memory card/stick and disk using the computer 112 peripherals.

Also, as part of the options during the image product/service process, the customer has the ability to embed into the image, personal identification information 210, as a digital watermark (for example as described in U.S. Pat. Nos. 5,859,920; 5,905,819; 6,044,182; 6,136,752 which are hereby incorporated it their entirety) to uniquely identify the generation of the image product through the user interface 102, the writing pad/sensor plate 114 or the imaging camera 101.

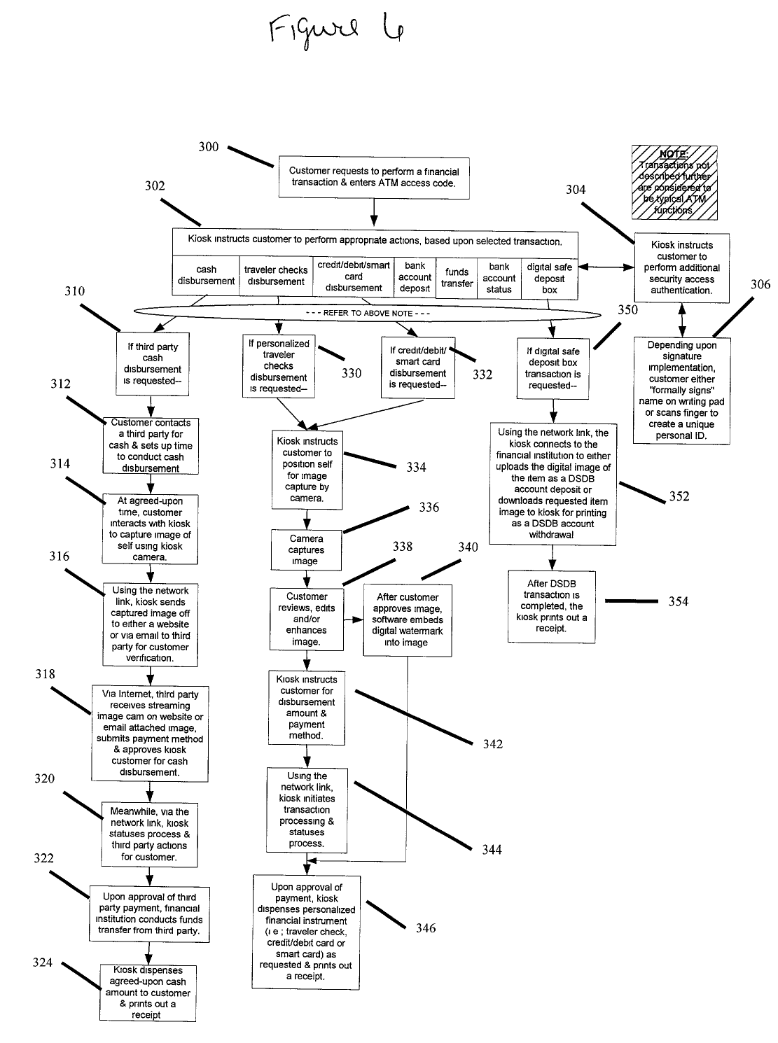

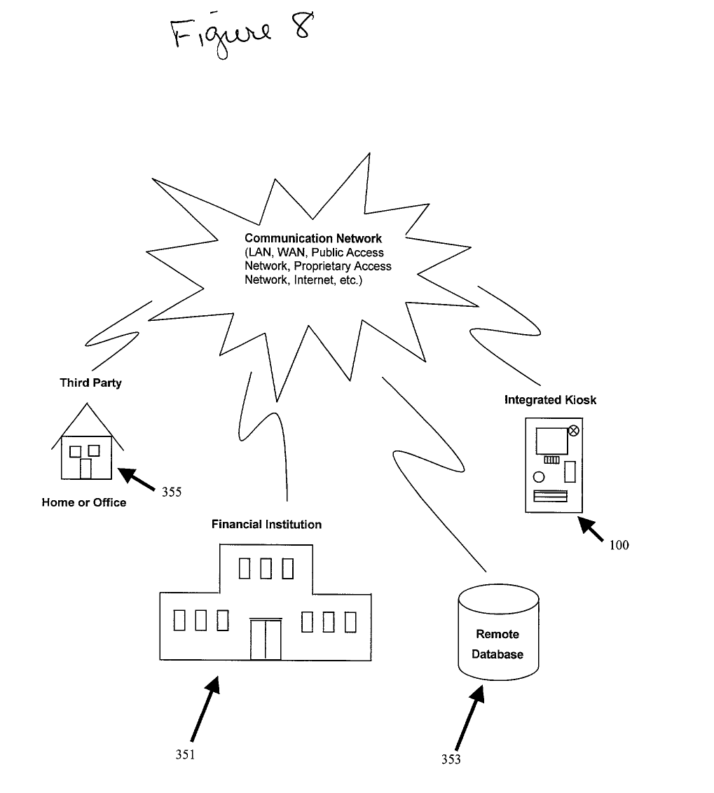

Referring to FIG. 6 there is illustrated various other forms of operation of the kiosk 100 in accordance with the present invention. For example, when a customer is interested in conducting a financial transaction 300, using kiosk 100, the customer would utilize user interface 102 and its associated screen prompts 302. In addition (or as an alternative) to using a PIN, an image of the customer is captured by imaging camera 101 and sent to a remote database 353, financial institution 350 or third party 355 (see FIG. 8) for authorization in conducting some ATM transactions. For example the image of the customer could be sent to the third party responsible for the disbursement for visual verification, or verification by comparing the captured image of the customer using image recognition software to an image on file. Additional security measures can be taken to secure transactions 304. For example when signature (e.g.; via hand-written or biometrics) is desired, the writing pad/sensor plate 114 (or the imaging camera 101 for an iris scan implementation) is used to authenticate the transaction process 306. The information obtained by these devices is analyzed and compared with stored information or information accessed over the communication network for verification. This verification may be done at the kiosk 100 or at the remote location. An envelope deposit slot 104 is provided for cash deposit transactions; similarly, card swiping, using the multicard reader 116, provides non-cash deposits/withdrawal capability. The customer follows the ATM prompts on the user interface 102, resulting in the financial transaction, which may include a cash disbursement, at the financial instrument dispenser 108. After the financial transaction has been completed, the smaller size printer 110 provides a receipt, as a record of the transaction 324; 346; 354.

In the prior two uses of the kiosk 100, the transaction and payment are made by the customer at the kiosk 100. The present invention allows for third party disbursement of funds 310 or payment on behalf of the customer at the kiosk 100. In one form of operation of the kiosk 100 the customer requesting the funds or services, contacts a third party 355 (see FIG. 8) over a communication network. One such example is over the internet using a telephone connected to the kiosk 100. Once the third party is connected to the kiosk 100, appropriate information can be entered by the third party over the communication network. This could be a valid credit card number, bank account etc. This information need not be given to the customer, but instead the information could be entered directly to the kiosk 100 over the communication network. The phone provided at kiosk is used to provide verification that the customer is who the third party 355 wishes to make payment for or authorize the release of funds to. The imaging camera 101 could allow visual verification of the customer at the kiosk 100 when the communication network is the internet and the third party is accessing the kiosk by a computer or other similar device. This allows the third party to view the customer for visual verification. The requested money or payment would then be authorized by the third party.

In another form of operation the third party agrees to a specific time to approve and forward the cash to the requester 312 kiosk 100 at an agreed-upon time. The requester (customer) goes to the integrated kiosk 100 and follows the user interface 102 prompts to capture an image of the requestor 314 from the imaging camera 101 and forward it via e-mail 316 over a communications network connection 118, such as the internet, to the third party at home or at any other location where the third party will be located. Simultaneously, the third party accesses the communication network and opens e-mail to verify that the image is that of the requestor 318. The e-mail also identifies the secure web site where the third party links to conduct the transaction and approve the cash disbursement. Depending upon the Internet access capability of the third party, the third party could view the requestor for visual verification. Depending on the kiosk network connection 118 and configuration, the third party would alternatively view a live cam broadcast of the requester on the designated web site. Meanwhile the user interface 102 is statusing the third party activities 320. Upon approval 322, the requestor initiates the cash disbursement and the cash is dispensed 324 at the financial instrument dispenser 108. A receipt is then generated at the smaller sized printer 110. Also, a receipt via e-mail is sent to the third party to acknowledge that the transaction has been completed. An example of the above could be when a child, the customer, wishes to obtain funds from a parent or other individual from a remote location. The parent would then authorize the issuance of the funds at the kiosk.

In another form of operation of kiosk 100, the customer can also have access to its own Digital Safe Deposit Box (DSDB) at the financial institution 350. Following the instructions on the user interface 102, from the DSDB account the customer can deposit, transfer or withdraw contents 352. To deposit into the DSDB account, the customer can either use the imaging camera 101 or the image scanner 106 to capture an image, or import a digital file at the computer 112 using the available peripherals or from remote storage using the network connection 118. To withdraw from the DSDB account, an item image in the DSDB account can be generated at the image printer 120. A receipt is then generated 354 at the smaller sized printer 110 at the completion of the DSDB transaction.

In another form of operation of kiosk 100, the kiosk also has the capability to generate personalized financial instruments 330; 332; 400. As one of the ATM transaction options, a customer can purchase personalized checks, travelers checks, or other financial instruments, through an appropriate financial institution 350 incorporating an image 401 of the bearer and/or the bearer's signature 402 printed on the travelers checks. For example a personal identification icon 404 is printed to provide visual authentication in using the travelers check. Through the user interface 102, the customer is instructed 334 to either get an image captured 336 via the imaging camera 101 or to scan a photograph on the image scanner 106. The customer reviews 338 and selects the desired image for the travelers check. For securing the selected financial instrument 330, the customer optionally uses the writing pad/sensor plate 114 to capture the bearer's signature for printing a signature representation of the bearer. While the customer interfaces with the kiosk to identify the disbursement amount and payment method 342, the application software within the computer 112, digitally watermarks 340 the image using the customer's unique information (e.g. customer signature and biometric information). The watermark provides the authentication of financial instrument provided by kiosk 100. Use of watermarking is well known in its prior art. Through the user interface 102 and network connection 118, the transaction process is initiated 344 and statused back to the customer. Upon approval of payment 346, the watermarked image, signature and/or personal identification indicator 404 is printed on the financial instrument. The personal identification indicator 404 provides a visual indication to the bearer and receiver of the financial instrument that it is a registered financial instrument where the image is secured by an embedded digital watermark. The correct number of financial instruments, such as travelers checks, are dispensed into the financial instrument dispenser 108 to equal the amount purchased. When the financial instrument is presented for payment at a desired merchant, the image on the financial can be compared to the presenter and the presenter can be asked to provide a second signature at location 403 for comparison and verification of the signature.

In the above embodiment the financial instrument is obtained at kiosk 100 and presented at desired merchant. It is also contemplated that financial instrument having the image and/or signature of the presenter could be cashed by the kiosk 100. For example if a financial instrument is made by a first kiosk 100, or by any other device, at a first location by a customer the financial instrument could be presented to a second kiosk 100 for payment. The customer would follow the instructions and prompts on the user interface 102. The financial instrument would be inserted into a scanner in kiosk 100 that would obtain the image and signature on the instrument. Then the customer could sign writing pad/sensor pad 114. The computer could then apply an appropriate algorithm for verification of the signature. In addition, the imaging camera 101 could capture the image of the presenter and the computer would apply an image comparison program for verifying that the image captured by imaging camera 101 is the same as the image on the instrument. Upon approval, the customer would insert the signed financial instrument into the envelope deposit slot 104, have its value verified and then cash would then be disbursed at the financial instrument dispenser 108.

While in the preferred invention is directed to the use of the ATM products/services with imaging products/services, the present invention is not so limited. Various other types of non-imaging products/services kiosks would share common features with an imaging kiosk, as an integrated kiosk, may be employed in the present invention.

The invention has been described in detail with particular reference to certain preferred embodiments thereof, but it will be understood that variations and modifications can be effected within the spirit and scope of the invention.

### Parts List

10 Kiosk (Imaging)

11 User Interface

12 Image Printer (Small Size)

14 Digital Image Camera

16 Computer

18 Image Printer (Large Size)

20 Multi-Card Reader

22 Image Scanner

24 Network Connection

40 Kiosk (ATM)

50 Security Camera

52 Display Device

54 Data Entry Device

56 Receipt Printer

58 Computer

60 Writing Pad/Sensor Plate

62 Multi-Card Reader

64 Network Connection

66 Envelope Deposit Slot

68 Financial Instrument Dispenser

100 Integrated Kiosk

101 Imaging Camera

102 User Interface

104 Envelope Deposit Slot

106 Image Scanner

108 Financial Instrument Dispenser

110 Small Size Image Printer

112 Computer (including peripherals & supporting software)

114 Writing Pad/Sensor Plate

116 Multi-Card Reader

117 Communication Device

118 Network Connection (communications network)

120 Large Size Image Printer

200 Step

202 Step

204 Step

206 Step

208 Step

210 Step

214 Step

216 Step

218 Step

300 Step

302 Step

304 Step

306 Step

310 Step

312 Step

314 Step

316 Step

318 Step

320 Step

322 Step

324 Step

330 Step

332 Step

334 Step

336 Step

338 Step

340 Step

342 Step

344 Step

346 Step

350 Step

351 Financial Institution

352 Step

353 Remote Database

354 Step

355 Third Party

400 Financial Instrument (custom product)

401 Image

402 Bearer's Signature

403 Location

404 Personal Identification Icon

What is claimed is:

1. A customer kiosk for providing at least one imaging service and at least one non-imaging service, said kiosk comprising:
a customer input device;
a computer device;
a display device; and
an image capture device for capturing an image at said kiosk which is to be utilized by each of the said at least two different services.

2. A customer kiosk according to claim 1 wherein said at least one non-imaging goods and/or service comprise an ATM product and/or service and said at least one image service comprises the providing of image goods and/or services.

3. A customer kiosk according to claim 1 further comprising a communication device for communicating with a remote database.

4. A customer kiosk according to claim 3 wherein said remote database includes information for identifying the user of said kiosk based on the information obtained by said image capture device.

5. A customer kiosk according to claim 1 wherein said image capture device is used for viewing of the user of said kiosk from a remote location or for incorporating the use of a captured image into the services provided by the said kiosk.

6. A customer kiosk according to claim 1 wherein said kiosk further comprising of at least one printer for printing onto a media.

7. A customer kiosk according to claim 3 wherein communication device may be used for forwarding images to a remote database for storage, transmitting images as part of providing services, and accessing a remote database over a communication network for obtaining images for printing on said media.

8. A customer kiosk according to claim 6 wherein said media comprises a financial instrument which includes an image, the signature and/or personal identification indicator of the person to whom the financial instrument is issued.

9. A customer kiosk according to claim 8 wherein said financial instrument comprises a traveler's check.

10. A customer kiosk according to claim 9 wherein said financial instrument includes a watermark for preventing illegal copying of said instrument.

11. A customer kiosk according to claim 1 wherein an image of the user of said kiosk is captured on said image capture device and is forwarded to a remote location for authentication of a user of said kiosk.

12. A customer kiosk according to claim 6 wherein said printer is provided with at least two sources of media upon which images may be printed.

13. A customer kiosk according to claim 12 wherein one of said sources of said media comprises media for the printing of a non-financial instrument and the second source of said media comprises media for printing of a financial instrument.

14. A customer kiosk according to claim 6 wherein said media comprises a receipt to record the transaction conducted during the customer session at the kiosk.

15. A customer kiosk according to claim 3 wherein said communication device can communicate over a broad bandwidth type communications network or a low bandwidth communication network.

16. A customer kiosk according to claim 15 wherein said low bandwidth communication network is used for transmission of small data files and said high bandwidth communication network is used for transmission of large data files.

17. A customer kiosk according to claim 1 further comprising a portable storage mechanism for reading and writing storage media upon which images may be stored.

18. A customer kiosk according to claim 17 wherein said storage media is dispensed as output product.

19. A customer kiosk according to claim 17 wherein said storage media for storing an image is utilized by the services at said kiosk.

20. A customer kiosk according to claim 3 wherein large data files are compressed for transmission on said communication network.

21. A customer kiosk for providing financial and imaging goods and/or services, comprising:
a customer input device;
a display device;
a mechanism for receiving and/or providing monetary transfer by the customer; and
a scanning device for scanning of documents provided to said kiosk.

22. A customer kiosk according to claim 21 further comprising:
a computer for controlling operation of said kiosk; and
a computer software program which when placed in said computer will allow automatic recognition with regard to pre-identified items on said documents that have been scanned by said scanning device.

23. A customer kiosk according to claim 22 wherein said item comprises a signature provided on said document.

24. A customer kiosk according to claim 22 wherein said item comprises a image provided on said document.

25. A customer kiosk according to claim 23 further comprising a camera for capturing an image of said customer.

25. A customer kiosk according to claim 24 wherein said kiosk includes software for comparing the image on said document with said image being captured by said image capture device for confirming that the two are the same.

27. A customer kiosk according to claim 21 further comprising a writing pad/sensor plate on which the customer may provide a signature and/or biometric information.

28. A customer kiosk according to claim 27 wherein said kiosk further includes a software program for comparing said signature made by said customer on said pad with respect to a stored signature of said customer.

29. A system for providing remote financial transactions, comprising:
a customer kiosk for providing financial and imaging goods and/or services, said kiosk having a customer input device; a display device; a mechanism for receiving and/or providing monetary transfer by the customer; and a scanning device for scanning of documents provided to said kiosk; and a communication mechanism for communicating with a computer system at a remote location and providing information to said computer system obtained by said scanning mechanism;
said computer system having a display device for viewing of information provide by said kiosk, a software program for analyzing said information for confirming said information is authentic and authorizing a financial transaction based on said analyzing of said information.

30. A method for providing financial and imaging goods and/or services from a kiosk having a customer input scanning device and a display device, said method comprising:
providing a financial document to said input scanning device, said financial document being issued to the user and having user identification;
scanning said financial document provided to said kiosk and obtaining said user identification; and
providing confirmation data to said kiosk for verification of said user identification.

31. A method according to claim 30 wherein said user identification comprises a signature of said user.

32. A method according to claim 30 wherein said user identification comprises a image of said user.

33. A method according to claim 30 said confirmation comprises:
providing a signature and/or biometric to a writing pad/sensor plate provided on said kiosk.

34. A method according to claim 30 wherein said confirmation comprises:
capturing an image of the user by a camera provided on said kiosk.

35. A method for conducting a financial transaction by a customer at a remote kiosk, comprising the steps of:
a. obtaining initial information about said customer at said kiosk;
b. obtaining corresponding information about said customer from a remote location;
c. comparing said initial information with said corresponding information for confirming the authenticity of said initial information; and
d. conducting a financial transaction based on said confirmation of the authenticity of said initial information.

36. A method according to claim 35 wherein said initial information comprises an image of said customer.

37. A method according to claim 35 wherein said image is obtained by scanning of a document.

38. A method according to claim 37 wherein said image comprises the signature of said customer.

39. A method according to claim 36 wherein said image is obtained by a camera provided at said kiosk.

40. A computer software product comprising a computer readable storage medium having a computer program which when loaded into a computer in a kiosk having a customer input scanning device and a display device causes the computer to perform the steps of:
scanning said financial document provided to said kiosk and obtaining said user identification; and
providing confirmation data to said kiosk for verification of said user identification.

41. A computer software product comprising a computer readable storage medium having a computer program which when loaded into a computer in a kiosk causes the computer to perform the steps of:
a. obtaining initial information about said customer at said kiosk;
b. obtaining corresponding information about said customer from a remote location;
c. comparing said initial information with said corresponding information for confirming the authenticity of said initial information; and
d. conducting a financial transaction based on said confirmation of the authenticity of said initial information.
